(19) United States
(12) Patent Application Publication
(10) Pub. No.: US 2006/0146445 A1
(43) Pub. Date: Jul. 6, 2006

(54) Erasure-resistant perpendicular magnetic recording media, systems & method of manufacturing same

(75) Inventors: Thomas Patrick Nolan, Fremont, CA (US); Samuel Dacke Harkness IV, Berkeley, CA (US); Chunghee Chang, Fremont, CA (US); Jianping Chen, Milpitas, CA (US)

Correspondence Address: MCDERMOTT WILL & EMERY LLP, 600 13TH STREET, N.W., WASHINGTON, DC, 20005-3096, US

(73) Assignee: SEAGATE TECHNOLOGY LLC.

(21) Appl. No.: 11/028,224

(22) Filed: Jan. 4, 2005

(51) Int. Cl. G11B 5/66; G11B 5/82

(52) U.S. Cl. 360/135; 428/829

(57) ABSTRACT

A perpendicular magnetic recording medium adapted for use with a single-pole magnetic transducer head comprises a non-magnetic substrate having a surface, and a layer stack formed over the substrate surface, comprising, in overlying sequence from the substrate surface:
(i) a magnetically soft underlayer (SUL) having a magnetic saturation value Mₛ and a thickness t; (ii) at least one non-magnetic interlayer; and (iii) at least one magnetically hard perpendicular recording layer;
wherein the product Mₛt of the SUL is selected to have a minimum value which provides a desired amount of head field channeling but is sufficiently large to provide a desired reduction of erasure of written bits.

### FIELD OF THE INVENTION

The present invention relates to improved high areal recording density perpendicular magnetic recording media and systems including a soft magnetic underlayer (SUL) optimized for high -media signal-to-noise ratio (SNR), high erasure resistance, ease of manufacture, and method of manufacturing same. The invention is of particular utility in the manufacture and use of data/information storage and retrieval media, e.g., hard disks, and systems comprising same and having very high areal recording/storage densities.

### BACKGROUND OF THE INVENTION

Magnetic media are widely used in various applications, particularly in the computer industry, and efforts are continually made with the aim of increasing the areal recording density, i.e., bit density of the magnetic media. Conventional thin-film type magnetic recording media, wherein a fine-grained polycrystalline magnetic alloy serves as the active recording layer, are generally classified as “longitudinal” or “perpendicular”, depending upon the orientation of the magnetic domains of magnetic material. In perpendicular magnetic recording media, residual magnetization is formed in a direction perpendicular to the surface of the magnetic medium, typically a layer of a magnetic material on a suitable substrate. Very high linear recording densities are obtainable by utilizing a “single-pole” magnetic transducer or “head” with such perpendicular magnetic media.

It is well-known that efficient, high bit density recording utilizing a perpendicular magnetic medium requires interposition of a relatively thick (i.e., as compared to the magnetic recording layer), magnetically “soft” underlayer (SUL) or “keeper” layer, i.e., a magnetic layer having a relatively low coercivity below about 1 kOe, between a non-magnetic substrate and a “hard” magnetic recording layer having perpendicular anisotropy K⊥ and a relatively high coercivity H_{c} of several kOe, typically about 3-6 kOe. The magnetically soft underlayer (SUL) e.g., of a NiFe alloy such as Permalloy serves to guide magnetic flux emanating from the head through the hard, perpendicular magnetic recording layer, typically comprised of a Co-based alloy material, such as CoCr. In addition, the magnetically soft underlayer (SUL) reduces susceptibility of the medium to thermally-activated magnetization reversal by reducing the demagnetizing fields which lower the energy barrier that maintains the current state of magnetization.

Referring to FIG. 1, a typical conventional perpendicular recording system 10 comprises a vertically oriented (i.e., perpendicular) magnetic medium 1 and a single-pole head 2. Medium 1 includes substrate 3, relatively thick soft magnetic underlayer (SUL) 4, at least one relatively thin non-magnetic (i.e., non-ferromagnetic) interlayer 5 (sometimes referred to as an “intermediate” layer), at least one relatively thin magnetically hard recording layer 6, and a thin protective overcoat layer 7. Interlayer 5 serves to: (1) prevent magnetic interaction between the SUL 4 and the recording layer 6 and (2) promote desired microstructural and magnetic properties of the magnetically hard recording layer 6.

As illustrated in FIG. 1, single-pole head 2 includes a main pole 8 and an auxiliary pole 9. As shown by the arrows in the figure indicating the path of the magnetic flux φ, flux φ is seen as emanating from main pole 8 of single-pole magnetic transducer head 2, entering and passing through vertically oriented, hard magnetic recording layer 6 in the region below main pole 8, entering and traveling along SUL 4 for a distance, and then exiting therefrom and passing through the perpendicular hard magnetic recording layer 6 in the region below auxiliary pole 9 of single-pole magnetic transducer head 2. The direction of movement of perpendicular magnetic medium 1 past transducer head 6 in the x-direction is indicated in the figure by the arrow above medium 1.

Perpendicular magnetic recording systems such as system 10 comprising perpendicular recording medium 1 include SUL 4 in order to channel the magnetic field from the main pole 8 of the single-pole head 2 and thereby increase the effective magnetic field applied to the magnetically hard recording layer 6. The increased magnetic field enables an increase in the media coercivity H_{c} which can be utilized, ultimately resulting in improvements in the media signal-to-noise ratio (SNR), thermal stability, and areal recording density. Disadvantageously, however, the magnetic structure of the SUL 4 can contribute to media noise, and the DC noise contribution may increase rapidly if the thickness of the SUL is sufficient such that stripe domains are formed, as described below in more detail. In addition, it is desirable from manufacturing and cost perspectives that the thickness of the SUL 4 be minimized.

With continued reference to FIG. 1, substrate 3 is typically disk-shaped and comprised of a non-magnetic metal or alloy, e.g., an Al-based alloy, such as Al—Mg having an Ni—P plating layer on the deposition surface thereof, or substrate 3 is comprised of a suitable glass, ceramic, glass-ceramic, polymeric material, or a composite or laminate of these materials. The relatively thick SUL 4 is typically comprised of an about 40-400 nm layer of a soft magnetic material selected from the group consisting of Ni, NiFe (Permalloy), Co, CoZr, CoZrCr, CoZrNb, CoFe, Fe, FeN, FeSiAl, FeSiAlN, FeCoC, etc. Relatively thin interlayer 5 typically comprises an up to about 30 nm thick layer of a non-magnetic material, such as TiCr. Magnetically hard recording layer 6 is typically comprised of an about 10 to about 25 nm thick layer of a Co-based alloy including one or more elements selected from the group consisting of Cr, Fe, Ta, Ni, Mo, Pt, V, Nb, Ge, B, and Pd, iron nitrides or oxides, or a (CoX/Pd or Pt)ₙ multilayer magnetic superlattice structure, where n is an integer from about 10 to about 25, each of the alternating, thin layers of Co-based magnetic alloy is from about 2 to about 3.5 Å thick, X is an element selected from the group consisting of Cr, Ta, B, Mo, Pt, W, and Fe, and each of the alternating thin, non-magnetic layers of Pd or Pt is up to about 10 Å thick. Each type of hard magnetic recording layer material has perpendicular anisotropy arising from magneto-crystalline anisotropy (1^{st} type) and/or interfacial anisotropy (2^{nd} type).

Completing medium 1 is a protective overcoat layer 7, such as a layer of a diamond-like carbon (DLC) formed over magnetic recording layer 6, and a lubricant topcoat layer (not shown in the figure for illustrative simplicity), e.g., a layer of a perfloropolyether material, formed over the protective overcoat layer 7.

As indicated above, a conventionally-configured perpendicular magnetic recording medium such as illustrated in FIG. 1 typically comprises a relatively thick SUL 4 of a high magnetization (Mₛ) material (such as those enumerated supra) which exhibits in-plane anisotropy dominated by shape anisotropy 4πnMₛ. However, since the SUL 4 is relatively thick, e.g., from about 40 to about 400 nm thick, it becomes difficult to maintain the magnetizations in an in-plane direction due to a perpendicular anisotropy component attributable to various factors, i.e., magneto-crystalline anisotropy and magneto-elastic anisotropy (see E. E. Huber et al., J. Appl. Phys. (suppl.) 30, 267S (1959) and S. K. Wang et al., IEEE Trans. Magn. 35, 782 (1999)). Perpendicular components of magnetizations caused by the perpendicular anisotropy component form “stripe” or “ripple” shaped domains (see K. Sin et al., IEEE Trans. Magn. 33, 2833 (1997) and N. Saito et al., J. Phys. Soc. Japan 19, 1116 (1964)), resulting in a significant amount of DC noise. According to common practice, the perpendicular anisotropy component in soft magnetic films attributable to the magneto-elastic anisotropy factor can be relieved by thermal annealing (see Jun Yu et al., MMM 2001 Conference).

Another way by which the perpendicular anisotropy component of the SUL may be suppressed is to form a laminated SUL structure, as by depositing a layer stack or laminate comprised of alternating layers of different materials (see F. Nakamura et al., 5th Perpendicular Magnetic Recording Conference (PMRC 2000), Sendai, Japan, Oct. 23-26, 2000, paper 23pA-13). Referring to FIG. 2, such a laminated SUL structure 4_{L} consists of a stacked plurality of alternating relatively thicker soft magnetic layers 4_{M} and relatively thinner spacer layers 4_{S} formed over the surface of a suitable substrate 3. An adhesion layer 3_{A} may be provided on the upper surface of the substrate 3, at the interface with the lowermost soft magnetic layer 4_{M}, which adhesion layer 3_{A} may be formed of the same material as that of the spacer layers 4_{S}. It is believed that the beneficial effect afforded by formation of the laminated SUL structure 4_{L} is obtained from a reduction of the perpendicular anisotropy component in polycrystalline soft magnetic films attributable to the magneto-crystalline anisotropy factor, the latter arising from disruption of columnar growth in the films.

Adverting to FIG. 3, shown therein is a simplified cross-sectional view of “pseudo-laminated” SUL/adhesion layer/substrate structure 40_{L} disclosed in commonly assigned U.S. patent application Ser. No. 10/143,983, filed May 14, 2002 (the entire contents of which are incorporated herein by reference) and in PCT publication WO 03/054862 published Jul. 3, 2003, which structure is suitable for use as an alternative to the conventional laminated structure shown in FIG. 2.

Pseudo-laminated SUL/adhesion layer/substrate structure 40_{L} comprises a plurality n (illustratively 3) of vertically stacked magnetically soft sub-layers 4_{M} formed over the surface of a suitable non-magnetic substrate 3 without intervening spacer layers 4_{S} such as are present in the laminated SUL structure 4_{L} of FIG. 2. The (integral) number n and thickness of each of the magnetically soft sub-layers 4_{M} depend upon the particular material thereof; and respectively range from 2 to 6 and from about 50 to about 130 nm. Suitable materials for use as each of the magnetically soft sub-layers 4_{M} include FeCoB, CoZr, CoZrCr, CoZrNb, CoTaZr, CoFeZr, and FeTaC. As in the laminated SUL structure 4_{L} shown in FIG. 2, pseudo-laminated SUL/adhesion layer/substrate structure 40_{L} may include an adhesion layer 3_{A} formed on the upper surface of the substrate 3, at the interface with the lowermost magnetically soft sub-layer 4_{M}, which adhesion layer 3_{A} may comprise an about 10 to about 50 Å thick layer of a material selected from the group consisting of Ti, Cr, Ta, Zr, Nb, Fe, Co, Ni, and alloys thereof. Pseudo-laminated structure 40_{L} may be readily and conveniently formed by sputtering, with alteration in the sputtering conditions of each magnetic sub-layer, if desired or necessary.

The optimal thickness of the SUL 4 from the viewpoints of SNR and manufacturing cost may vary depending upon SUL parameters such as saturation magnetic moment (Mₛ), as well as upon the coercivity H_{c} of medium 1 and efficiency of the head 2. For a high Mₛ SUL 4, e.g., Mₛ˜1,500-2,000 emu/cm³, with a low intrinsic noise contribution and no detrimental effects on growth thereon of subsequent layers, a comparably high SNR is possible for saturation magnetization-thickness products (Mₛt) ranging from less than about 15 memu/cm² to more than about 50 memu/cm². Corresponding film thicknesses of SUL 4 are expected to range from less than about 100 nm to more than about 300 nm. From a manufacturing viewpoint, it is desirable to select the lowest satisfactory thickness within this range.

It is also desirable that perpendicular recording media be resistant to erasure of written bits by head 2 or by stray magnetic fields which are disadvantageously channeled to recording layer 6. It has been determined that such erasure frequently can be another limiting factor in the design of perpendicular magnetic recording systems such as system 10 and media 1. In particular, strong erasure is commonly observed in some media at distances as far from the written bit tracks as the width of the main pole 8 of single-pole head 2.

In view of the foregoing, there exists a clear need for improved perpendicular magnetic recording media and systems, and methods of manufacture therefor, which media include a soft magnetic underlayer (SUL) optimized for high media signal-to-noise ratio (SNR) and high erasure resistance, do not adversely affect growth of subsequently deposited constituent layers, inhibit or prevent formation of low frequency or stripe domain noise, and utilize the thinnest SUL thickness for ease of manufacture.

The present invention, therefore, addresses and solves problems attendant upon the design and manufacture of high performance, high areal recording density perpendicular magnetic recording media and systems, while maintaining full compatibility with the economic requirements of cost-effective, large-scale automated manufacturing technology.

### DISCLOSURE OF THE INVENTION

An advantage of the present invention is an improved perpendicular magnetic recording medium.

Another advantage of the present invention is an improved perpendicular magnetic recording medium adapted for use with a single-pole magnetic transducer head.

Still another advantage of the present invention is an improved perpendicular magnetic recording system.

Yet another advantage of the present invention is an improved perpendicular magnetic recording system including a single-pole magnetic transducer head.

A further advantage of the present invention is an improved method of manufacturing a perpendicular magnetic recording medium.

A still further advantage of the present invention is an improved method of manufacturing a perpendicular magnetic recording medium adapted for use with a single-pole magnetic transducer head.

These and additional advantages and other features of the present invention will be set forth in the description which follows and in part will become apparent to those having ordinary skill in the art upon examination of the following or may be learned from the practice of the present invention. The advantages of the present invention may be realized as particularly pointed out in the appended claims.

According to an aspect of the present invention, the foregoing and other advantages are obtained in part by a perpendicular magnetic recording medium, comprising:

(a) a non-magnetic substrate having a surface; and

(b) a layer stack formed over the substrate surface, the layer stack comprising, in overlying sequence from the substrate surface:
(i) a magnetically soft underlayer (SUL) having a magnetic saturation value M_{s(SUL)} and a thickness t;
(ii) at least one non-magnetic interlayer; and
(iii) at least one magnetically hard perpendicular recording layer;

wherein the product (M_{s(SUL)}t) of the magnetic saturation (M_{s(SUL)}) and thickness (t) of the SUL has a minimum value which provides a desired amount of transducer head field channeling but is sufficiently large to provide a desired reduction of erasure of written bits.

In accordance with preferred embodiments of the present invention, the perpendicular recording medium is adapted for use in a magnetic recording system including a single pole magnetic transducer head comprising a main pole having a length λ, a magnetic saturation value M_{s(head)}, a saturation current Iₛₐₜ, and a write current I_{w}; and wherein the thickness t of the SUL is determined based upon the design rule:
t>(λM_{s(head)}I_{w})/M_{s(SUL)}Iₛₐₜ
in order to eliminate written bit erasure due to a head field traversing laterally away from a written track and saturating a head pole comer.

According to certain preferred embodiments of the present invention, the write current I_{w} is equal to the saturation current Iₛₐₜ, whereby the thickness t of the SUL is determined based upon the design rule:
t>(λM_{s(head)}/M_{s(SUL)}.

Preferred embodiments of the invention include those wherein the thickness t of the SUL is one of the following:

(a) the calculated thickness t_{calc} according to the design rule;

(b) between about 0.7 and about 1.5 times t_{calc}; and

(c) between about 0.8 and about 1.2 times t_{calc}.

According to further preferred embodiments of the invention, the SUL comprises a layer of an amorphous magnetic material and includes a smooth surface facing the magnetically hard recording layer; the amorphous magnetic material of the SUL is free from low frequency grain noise and stripe domains and has a high M_{s(SUL)} value at least about 1,500 emu/cm³ for minimizing the thickness t of the SUL providing the M_{s(SUL)}t product.

According to certain preferred embodiments, M_{s(SUL)}t of the SUL is <˜15 memu/cm²; whereas, according to certain other preferred embodiments, M_{s(SUL)}t of the SUL is >˜15 memu/cm², and the SUL is a laminated structure comprising a plurality of layers of the amorphous magnetic material separated by respective thin spacer layers of a non-magnetic material or a pseudo-laminated structure comprising a stacked plurality of contacting sub-layers of the amorphous magnetic material.

Further preferred embodiments of the invention include those wherein the non-magnetic substrate comprises glass or an Al-based alloy with an adhesion layer comprising a non-magnetic amorphous material on the surface thereof, and the layer stack includes a laminated SUL comprised of a plurality of amorphous Fe-based alloy layers separated by amorphous, non-magnetic spacer layers, an hcp interlayer with <0001> preferred growth orientation, a small-grain, low exchange coupled, hcp Co-based alloy magnetic recording layer, a hard carbon-containing protective overcoat, and a lubricant topcoat.

Another aspect of the present invention is an improved perpendicular magnetic recording system, comprising:

(a) a single-pole magnetic transducer head comprising a main pole having a length λ, a magnetic saturation value M_{s(head)}, a saturation current Iₛₐₜ, and a write current I_{w}; and

(b) a perpendicular magnetic recording medium adapted for use with the single-pole magnetic transducer head, comprising:
(i) a non-magnetic substrate having a surface; and
(ii) a layer stack formed over the substrate surface, the layer stack comprising, in overlying sequence from the substrate surface:
   (1) a magnetically soft underlayer (SUL) having a magnetic saturation value M_{s(SUL)} and a thickness t;
   (2) at least one non-magnetic interlayer; and
   (3) at least one magnetically hard perpendicular recording layer;

wherein the product (M_{s(SUL)}t) of the magnetic saturation (M_{s(SUL)}) and thickness (t) of the SUL has a minimum value which provides a desired amount of head field channeling but is sufficiently large to provide a desired reduction of erasure of written bits.

According to preferred embodiments of the invention, the thickness t of the SUL is determined based upon the design rule:
t>(λM_{s(head)}I_{w})/M_{s(SUL)}Iₛₐₜ
in order to eliminate written bit erasure due to a head field traversing laterally away from a written track and saturating a head pole corner.

In accordance with certain preferred embodiments of the invention, the write current I_{w} is equal to the saturation current Iₛₐₜ, whereby the thickness t of the SUL is determined based upon the design rule:
t>(λM_{s(head)}/M_{s(SUL)}.

In accordance with further preferred embodiments of the present invention, the thickness t of the SUL is selected from the following:

(a) the calculated thickness t_{calc} according to the design rule;

(b) between about 0.7 and about 1.5 times t_{calc}; and

(c) between about 0.8 and about 1.2 times t_{calc}

According to preferred embodiments of the present invention, the SUL comprises a layer of an amorphous magnetic material and includes a smooth surface facing the magnetically hard recording layer; and the amorphous magnetic material of the SUL is free from low frequency grain noise and stripe domains and has a high M_{s(SUL)} value at least about 1,500 emu/cm³ for minimizing the thickness t of the SUL providing the M_{s(SUL)}t product.

In accordance with certain preferred embodiments of the invention, M_{s(SUL)}t of the SUL is <˜15 memu/cm²; whereas, according to certain other preferred embodiments of the invention, M_{s(SUL)}t of the SUL is >˜15 memu/cm², and the SUL comprises a laminated structure, wherein the laminated structure comprises a plurality of layers of the amorphous magnetic material separated by respective thin spacer layers of a non-magnetic material or a pseudo-laminated structure comprising a stacked plurality of contacting sub-layers of the amorphous magnetic material.

Preferred embodiments of the present invention include those wherein the non-magnetic substrate comprises glass or an Al-based alloy with an adhesion layer comprising a non-magnetic amorphous material on the surface thereof, and the layer stack includes a laminated SUL comprised of a plurality of amorphous Fe-based alloy layers separated by amorphous, non-magnetic spacer layers, an hcp interlayer with <0001> preferred growth orientation, a small-grain, low exchange coupled, hcp Co-based alloy magnetic recording layer, a hard carbon-containing protective overcoat, and a lubricant topcoat.

Yet another aspect of the present invention is a method of manufacturing a perpendicular magnetic recording medium, comprising:

providing a non-magnetic substrate having a surface; and

forming a layer stack over the substrate surface, the layer stack comprising, in overlying sequence from the substrate surface:
(1) a magnetically soft underlayer (SUL) having a magnetic saturation value M_{s(SUL)} and a thickness t;
(2) at least one non-magnetic interlayer; and
(3) at least one magnetically hard perpendicular recording layer; wherein:

the product M_{s(SUL)}t) of the magnetic saturation (M_{s(SUL)}) and thickness (t) of the SUL has a minimum value which provides a desired amount of head field channeling but is sufficiently large to provide a desired reduction of erasure of written bits.

According to preferred embodiments of the invention, the method comprises forming a perpendicular magnetic recording medium adapted for use with a single-pole magnetic transducer head comprising a main pole with a length λ, and having a magnetic saturation value M_{s(head)}, a saturation current Iₛₐₜ, and a write current I_{w}, wherein the thickness t of the SUL is determined based upon the design rule:
t>(λM_{s(head)}I_{w})/M_{s(SUL)}Iₛₐₜ
in order to eliminate written bit erasure due to a head field traversing laterally away from a written track and saturating a head pole corner.

In accordance with a preferred embodiment of the invention, the method comprises forming a perpendicular magnetic recording medium wherein the write current I_{w} is equal to the saturation current Iₛₐₜ, and the thickness t of the SUL is determined based upon the design rule:
t>(λM_{s(head)}/M_{s(SUL)}.

Preferred embodiments of the invention include those wherein the method comprises selecting the thickness t of the SUL from the following:

(a) the calculated thickness t_{calc} according to the design rule;

(b) between about 0.7 and about 1.5 times t_{calc}; and

(c) between about 0.8 and about 1.2 times t_{calc}

Further preferred embodiments of the invention include those wherein the method comprises forming a perpendicular magnetic recording medium wherein the SUL comprises a layer of an amorphous magnetic material which includes a smooth surface facing the magnetically hard recording layer; and the amorphous magnetic material is free from low frequency noise and stripe domains and has a high M_{s(SUL)} value at least about 1,500 emu/cm³ for minimizing the thickness t of the SUL.

According to certain preferred embodiments of the invention, the method comprises forming a perpendicular magnetic recording medium wherein M_{s(SUL)}t of the SUL is <˜15 memu/cm²; whereas, according to certain other preferred embodiments of the invention, the method comprises forming a perpendicular magnetic recording medium wherein M_{s(SUL)}t of the SUL is >˜15 memu/cm², and the SUL comprises a laminated structure including a plurality of layers of the amorphous magnetic material separated by respective thin spacer layers of a non-magnetic material or a pseudo-laminated structure including a stacked plurality of contacting sub-layers of the amorphous magnetic material.

Further preferred embodiments of the invention include those wherein the method comprises forming at least the SUL by sputter deposition, and where the method comprises providing a non-magnetic glass or Al-based alloy substrate with an adhesion layer comprising a non-magnetic amorphous material on the surface thereof, and forming thereon a layer stack including a laminated SUL comprised of a plurality of amorphous Fe-based alloy layers separated by amorphous, non-magnetic spacer layers, an hcp interlayer with <0001> preferred growth orientation, a small-grain, low exchange coupled, hcp Co-based alloy magnetic recording layer, a hard carbon-containing protective overcoat, and a lubricant topcoat.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects, all without departing from the spirit of the present invention. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the various features are not necessarily drawn to scale but rather are drawn as to best illustrate the pertinent features, and in which like reference numerals are employed throughout to designate similar features, wherein:

FIG. 1 schematically illustrates, in simplified cross-sectional view, a portion of a magnetic recording, storage, and retrieval system comprised of a single-pole magnetic transducer head and a conventional perpendicular type magnetic recording medium including a soft magnetic underlayer (SUL), a non-magnetic interlayer, and a perpendicular hard magnetic recording layer;

FIG. 2 schematically illustrates, in simplified cross-sectional view, a portion of a laminated SUL/adhesion layer/substrate structure according to the prior art, for use in perpendicular magnetic recording media such as illustrated in FIG. 1, and comprising a stacked plurality of alternating, relatively thicker soft magnetic layers separated by relatively thinner spacer layers;

FIG. 3 schematically illustrates, in simplified cross-sectional view, a portion of a pseudo-laminated SUL/adhesion layer/substrate structure according to the prior art, for use in perpendicular magnetic recording media such as illustrated in FIG. 1, and comprising a stacked plurality of separately-deposited, contacting, soft magnetic sub-layers;

FIG. 4 schematically illustrates, in simplified cross-sectional view, a portion of an embodiment of an improved, erasure-resistant perpendicular magnetic recording medium according to an embodiment of the present invention, adapted for use in a single-pole system such as illustrated in FIG. 1; and

FIG. 5 is a graph for illustrating the variation of % erasure with SUL thickness of an improved perpendicular magnetic recording medium according to the invention.

### DESCRIPTION OF THE INVENTION

The present invention is based upon recognition by the inventors that improved, very high areal recording density perpendicular magnetic recording media, and recording systems comprising same, can be reliably and controllably fabricated with increased erasure resistance, improved SNR, elimination of stripe domains, and ease of manufacturability, by appropriate design and optimization of the soft magnetic underlayer (SUL) of the perpendicular media.

According to the several features of the present invention:

1. the SUL comprises a high (i.e., at least about 1,500 emu/cm³) magnetic saturation (Mₛ) material of amorphous microstructure and reduced surface roughness. The high value of M_{s(SUL)} allows for a reduced SUL thickness t for a desired M_{s(SUL)}t product; and the reduced surface roughness decreases detrimental effects of the thickness of the SUL upon the microstructure of layers subsequently deposited thereon. In addition, the reduced surface roughness decreases detrimental effects of the SUL upon the crystallographic preferred orientation of layers subsequently deposited thereon, e.g., as measured by X-ray rocking curves;

2. the amorphous, high M_{s(SUL)} material is found to be substantially free from low frequency grain noise and formation of stripe domains when M_{s(SUL)}t<15 memu/cm². When M_{s(SUL)}t<15 memu/cm², it is necessary to separate portions, segments, or regions (e.g., sub-layers) of the SUL by insertion of thin, non-magnetic spacer layers, as in the laminated SUL structure shown in FIG. 2 and described supra, or by forming a pseudo-laminated structure as shown in FIG. 3 and described supra, comprising a plurality of sub-layers of SUL material deposited under varying (e.g., alternating) conditions; and

3. erasure of recorded bits due to traversal of the head-field laterally away from a written track and saturating a corner of the transducer head pole is substantially eliminated by observing the following design rule for the thickness t of the SUL, wherein the single-pole magnetic transducer head comprises a main pole with a length λ, has a magnetic saturation value M_{s(head)}, a saturation current Iₛₐₜ, and a write current I_{w}:
t>(λM_{s(head)}I_{w})/M_{s(SUL)}Isat. (1)

For example, for a transducer head with a main pole length of 9 μin. (2.3×10⁻⁵ cm), saturating at Iₛₐₜ=30 mA, writing at I_{w}=20 mA, and with a magnetic saturation value M_{s(head)}=2,400 emu/cm³, the thickness t of the SUL of a perpendicular recording medium according to the above design rule, when the SUL material has a magnetic saturation value M_{s(SUL)}, is >203 nm.

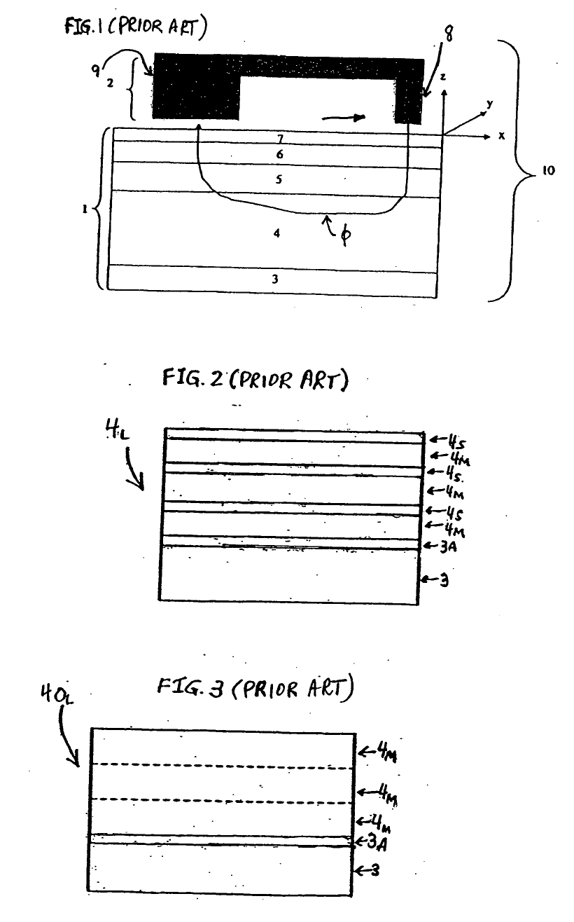

In this instance, the head field primarily travels directly from the main (i.e., write) pole of the transducer to the auxiliary (i.e., return) pole through a high permeability path, and bit erasure is low. Higher flux saturates the SUL in the path along the x-z plane (see FIG. 1) exiting the main pole. H field lines then must emanate from a larger area of the pole structure or travel laterally from the main pole structure in order to follow a low permeability path to the auxiliary pole. This H field passes through the recording layer on neighboring tracks and contributes to high off-track erasure.

Therefore, according to the invention, the thickness t and the number of laminations of the SUL are selected as to minimize the M_{s(SUL)}t product while providing a sufficient amount of head field channeling, but have a sufficient M_{s(SUL)}t product according to the design rule to reduce recorded bit erasure. For low recorded bit erasure operation at any write current I_{w}, the latter should be set equal to the saturation current Iₛₐₜ, whereby the design rule (1) simplifies to:
t>(λM_{s(head)}/M_{s(SUL)}. (2)

According to a preferred embodiment of the invention, the amorphous SUL is deposited by sputter deposition at sputter gas pressures below about 3 mTorr in order to minimize surface roughness of the deposited film resulting from ion bombardment and re-sputtering during deposition, the magnetic saturation value M_{s(SUL)} of the SUL material is at least about 1,500 emu/cm³, and the value of the M_{s(SUL)}t product is selected to be greater than that required to maximize the SNR in order to reduce recorded bit erasure.

According to a preferred embodiment, the thickness t of the SUL is the calculated design rule thickness t_{calc}; whereas, according to a more preferred embodiment, the thickness t is selected to be between about 0.7 and about 1.5 times t_{calc}. According to an even more preferred embodiment, the thickness t is selected to be between about 0.8 and about 1.2 times t_{calc}.

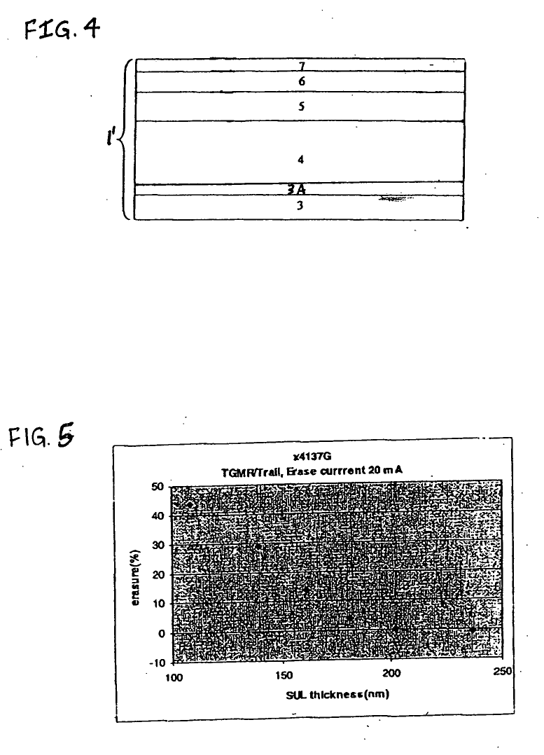

Referring to FIG. 4, shown therein, in simplified cross-sectional view, is a portion of an embodiment of an improved, erasure-resistant perpendicular magnetic recording medium 1′ according to an illustrative, but non-limitative, embodiment of the present invention, adapted for use in a single-pole system such as illustrated in FIG. 1. More specifically, perpendicular magnetic recording medium 1′ resembles the conventional perpendicular magnetic recording medium of FIG. 1, and comprises a series of thin-film layers arranged in an overlying (stacked) sequence on a suitable non-magnetic substrate 3 (which may have formed thereon a thin adhesion layer 3A), and includes a soft magnetic underlayer (SUL) 4′ according to the invention (described below in more detail), a thin interlayer 5 for promoting a desired crystallographic orientation of an overlying layer, a hard magnetic recording layer 6 with the desired crystallographic orientation, a protective overcoat layer 7, and a lubricant topcoat layer (not shown in the figure for illustrative simplicity).

Except as described below, each of the constituent layers of medium 1′ is essentially similar in composition and thickness to the respective constituent layers of conventional medium 1 as shown in FIG. 1 and described supra, and may be formed by utilizing at least one physical vapor deposition (PVD) technique selected from sputtering, reactive sputtering, vacuum evaporation, ion plating, ion beam deposition (IBD), and plasma deposition, or at least one chemical or plasma-assisted chemical vapor deposition method selected from CVD, MOCVD, and PECVD. The lubricant topcoat layer may be formed by utilization of at least one method selected from dipping, spraying, and vapor deposition.

According to embodiments of the invention, substrate 3 comprises glass or an Al-based alloy and is provided with an adhesion layer 3A on the surface thereof, comprised of an amorphous, non-magnetic material as is known in the art; SUL 4′ comprises a laminated structure such as 4_{L} shown in FIG. 2 and described supra or a pseudo-laminated structure such as 40_{L} shown in FIG. 3 and described supra; interlayer 5 comprises an hcp-oriented layer of a non-magnetic material, e.g., a Ru-based alloy; magnetically hard recording layer 6 comprises a small-grained, low exchange coupled, Co-based alloy with hcp <0001> preferred growth orientation; protective overcoat layer 7 comprises a hard carbon-containing material, e.g., DLC; and the lubricant topcoat comprises a perfluoropolyether compound.

As indicated supra, the laminated SUL structure 4_{L} consists of a stacked plurality of alternating relatively thicker soft magnetic layers 4_{M} and relatively thinner spacer layers 4_{S} formed over the surface of a suitable substrate 3. An adhesion layer 3_{A} may be provided on the upper surface of the substrate 3, at the interface with the lowermost soft magnetic layer 4_{M}, which adhesion layer 3_{A} may be formed of the same material as that of the spacer layers 4_{S}. According to the invention, the materials of the soft magnetic and spacer layers, their thicknesses, and number of lamination cycles are selected in accordance with the principles and design rule as set forth supra in order to provide desired t and M_{s(SUL)} values. Stated differently, according to the invention, the thickness t of SUL 4′ and number of lamination cycles n are selected so as to minimize M_{s(suL)}t while providing sufficient head channeling, and having sufficient M_{s(SUL)t} to reduce erasure according to the design rule.

By contrast, pseudo-laminated SUL/adhesion layer/substrate structure 40_{L} comprises a plurality n of vertically stacked magnetically soft sub-layers 4_{M} formed over the surface of a suitable non-magnetic substrate 3 without intervening spacer layers 4_{S} such as are present in the laminated SUL structure 4_{L} of FIG. 2. As before, the material, (integral) number n, and thickness of each of the magnetically soft sub-layers 4_{M} are selected in accordance with the principles and design rule as set forth supra in order to provide desired t and M_{s(SUL)}t values. Suitable materials for use as each of the magnetically soft sub-layers 4_{M} include FeCoB, CoZr, CoZrCr, CoZrNb, CoTaZr, CoFeZr, and FeTaC. As in the laminated SUL structure 4_{L} shown in FIG. 2, pseudo-laminated SUL/adhesion layer/substrate structure 40_{L} may include an adhesion layer 3_{A} formed on the upper surface of the substrate 3, at the interface with the lowermost magnetically soft sub-layer 4_{M}. Pseudo-laminated structure 40_{L} may be readily and conveniently formed by sputtering, with alteration in the sputtering conditions of each magnetic sub-layer, if desired or necessary.

According to a preferred embodiment of the invention, the thickest SUL laminate or pseudo-laminate 4_{L} or 40_{L} has M_{s(SUL)}t<15 memu/cm². Another preferred embodiment of the invention has the number of lamination cycles n set equal to the ratio (total SUL M_{s(SUL)}t/15 memu/cm²)+1.

Referring to FIG. 5, shown therein is a graph illustrating the variation of % erasure with SUL thickness of an improved perpendicular magnetic recording medium according to the invention, which graph shows data consistent with the above design rule. For SUL's thick enough to permit writing of the medium, erasure decreases rapidly until the design rule criterion is met at an SUL thickness of about 203 nm.

Thus, the present invention advantageously provides improved performance, high areal density, magnetic alloy-based perpendicular magnetic data/information and storage retrieval media and systems, and methods therefor, which media include an improved soft magnetic underlayer (SUL) which afford improved performance characteristics, such as SNR, erasure resistance, elimination of stripe domains, and facilitate manufacture thereof. The media of the present invention are especially useful when employed in conjunction with single-pole recording/retrieval transducer heads and enjoy particular utility in high recording density systems for computer-related applications. In addition, the inventive media can be fabricated by means of conventional media manufacturing technologies, e.g., sputtering.

In the previous description, numerous specific details are set forth, such as specific materials, structures, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

What is claimed is:

1. A perpendicular magnetic recording medium, comprising:
(a) a non-magnetic substrate having a surface; and
(b) a layer stack formed over said substrate surface, said layer stack comprising, in overlying sequence from said substrate surface:
(i) a magnetically soft underlayer (SUL) having a magnetic saturation value M_{s(SUL)} and a thickness t;
(ii) at least one non-magnetic interlayer; and
(iii) at least one magnetically hard perpendicular recording layer;
wherein the product (M_{s(SUL)}t) of said magnetic saturation (M_{s(SUL)}) and said thickness (t) of said SUL has a minimum value which provides a desired amount of transducer head field channeling but is sufficiently large to provide a desired reduction of erasure of written bits.

2. The recording medium as in claim 1, adapted for use in a magnetic recording system including a single pole magnetic transducer head comprising a main pole having a length λ, a magnetic saturation value M_{s(head)}, a saturation current Iₛₐₜ, and a write current I_{w};
wherein said thickness t of said SUL is determined based upon the design rule:
t>(λM_{s(head)}I_{w})/M_{s(SUL)}Iₛₐₜ
in order to eliminate written bit erasure due to a head field traversing laterally away from a written track and saturating a head pole comer.

3. The recording medium as in claim 2, wherein said write current I_{w} is equal to said saturation current Iₛₐₜ, whereby said thickness t of said SUL is determined based upon the design rule:
t>(λM_{s(head)}/M_{s(SUL)}.

4. The recording medium as in claim 2, wherein said thickness t of said SUL is selected from the following:
(a) the calculated thickness t_{calc} according to said design rule;
(b) between about 0.7 and about 1.5 times t_{calc}; and
(c) between about 0.8 and about 1.2 times t_{calc}

5. The recording medium as in claim 1, wherein:
said SUL comprises a layer of an amorphous magnetic material and includes a smooth surface facing said magnetically hard recording layer.

6. The recording medium as in claim 5, wherein:
said amorphous magnetic material of said SUL is free from low frequency grain noise and stripe domains and has a high M_{s(SUL)} value at least about 1,500 emu/cm³ for minimizing said thickness t of said SUL providing said M_{s(SUL)}t product.

7. The recording medium as in claim 6, wherein:
M_{s(SUL)}t of said SUL is <˜15 memu/cm².

8. The recording medium as in claim 6, wherein:
M_{s(SUL)}t of said SUL is >˜15 memu/cm².

9. The recording medium as in claim 8, wherein:
said SUL is a laminated structure comprising a plurality of layers of said amorphous magnetic material separated by respective thin spacer layers of a non-magnetic material or a pseudo-laminated structure comprising a stacked plurality of contacting sub-layers of said amorphous magnetic material.

10. The recording medium as in claim 1, wherein:
said non-magnetic substrate comprises glass or an Al-based alloy with an adhesion layer comprising a non-magnetic amorphous material on said surface, and said layer stack includes a laminated SUL comprised of a plurality of amorphous Fe-based alloy layers separated by amorphous, non-magnetic spacer layers, an hcp interlayer with <0001> preferred growth orientation, a small-grain, low exchange coupled, hcp Co-based alloy magnetic recording layer, a hard carbon-containing protective overcoat, and a lubricant topcoat.

11. A perpendicular magnetic recording system, comprising:
(a) a single-pole magnetic transducer head comprising a main pole having a length λ, a magnetic saturation value M_{s(head)}, a saturation current Iₛₐₜ, and a write current I_{w}; and
(b) a perpendicular magnetic recording medium adapted for use with said single-pole magnetic transducer head, comprising:
(i) a non-magnetic substrate having a surface; and
(ii) a layer stack formed over said substrate surface, said layer stack comprising, in overlying sequence from said substrate surface:
(1) a magnetically soft underlayer (SUL) having a magnetic saturation value M_{s(SUL)} and a thickness t;
(2) at least one non-magnetic interlayer; and
(3) at least one magnetically hard perpendicular recording layer;
wherein the product (M_{s(SUL)}t) of said magnetic saturation (M_{(SUL)}) and said thickness (t) of said SUL has a minimum value which provides a desired amount of head field channeling but is sufficiently large to provide a desired reduction of erasure of written bits.

12. The perpendicular magnetic recording system as in claim 11, wherein said thickness t of said SUL is determined based upon the design rule:
t>(λM_{s(head)}I_{w})/M_{s(SUL)}Iₛₐₜ
in order to eliminate written bit erasure due to a head field traversing laterally away from a written track and saturating a head pole corner.

13. The perpendicular magnetic recording system as in claim 12, wherein said write current I_{w} is equal to said saturation current Iₛₐₜ, whereby said thickness t of said SUL is determined based upon the design rule:
t>(λM_{s(head)}/M_{s(SUL)}.

14. The perpendicular magnetic recording system as in claim 12, wherein said thickness t of said SUL is selected from the following:
(a) the calculated thickness t_{calc} according to said design rule;
(b) between about 0.7 and about 1.5 times t_{calc}; and
(c) between about 0.8 and about 1.2 times t_{calc}

15. The perpendicular magnetic recording system as in claim 11, wherein:
said SUL comprises a layer of an amorphous magnetic material and includes a smooth surface facing said magnetically hard recording layer.

16. The perpendicular magnetic recording system as in claim 15, wherein:
said amorphous magnetic material of said SUL is free from low frequency grain noise and stripe domains and has a high M_{s(SUL)} value at least about 1,500 emu/cm³ for minimizing said thickness t of said SUL providing said M_{s(SUL)}t product.

17. The perpendicular magnetic recording system as in claim 16, wherein:
M_{s(SUL)}t of said SUL is <˜15 memu/cm².

18. The perpendicular magnetic recording system as in claim 16, wherein:
M_{s(SUL)}t of said SUL is >˜15 memu/cm².

19. The perpendicular magnetic recording system as in claim 18, wherein:
said SUL comprises a laminated structure, wherein said laminated structure comprises a plurality of layers of said amorphous magnetic material separated by respective thin spacer layers of a non-magnetic material or a pseudo-laminated structure comprising a stacked plurality of contacting sub-layers of said amorphous magnetic material.

20. The perpendicular magnetic recording system as in claim 11, wherein:
said non-magnetic substrate comprises glass or an Al-based alloy with an adhesion layer comprising a non-magnetic amorphous material on said surface, and said layer stack includes a laminated SUL comprised of a plurality of amorphous Fe-based alloy layers separated by amorphous, non-magnetic spacer layers, an hcp interlayer with <0001> preferred growth orientation, a small-grain, low exchange coupled, hcp Co-based alloy magnetic recording layer, a hard carbon-containing protective overcoat, and a lubricant topcoat.

21. A method of manufacturing a perpendicular magnetic recording medium, comprising:
forming a perpendicular magnetic recording medium, comprising:
(i) providing a non-magnetic substrate having a surface; and
(ii) forming a layer stack over said substrate surface, said layer stack comprising, in overlying sequence from said substrate surface:
(1) a magnetically soft underlayer (SUL) having a magnetic saturation value M_{s(SUL)} and a thickness t;
(2) at least one non-magnetic interlayer; and
(3) at least one magnetically hard perpendicular recording layer;
wherein the product (M_{s(SUL)}t) of said magnetic saturation (M_{s(SUL)}) and said thickness (t) of said SUL has a minimum value which provides a desired amount of head field channeling but is sufficiently large to provide a desired reduction of erasure of written bits.

22. The method according to claim 21, comprising:
forming a perpendicular magnetic recording medium adapted for use with a single-pole magnetic transducer head comprising a main pole having a length λ, a magnetic saturation value M_{s(head)}, a saturation current Iₛₐₜ, and a write current I_{w}, wherein said thickness t of said SUL is determined based upon the design rule:
t>(λM_{s(head)}I_{w}/M_{s(SUL)}Iₛₐₜ
in order to eliminate written bit erasure due to a head field traversing laterally away from a written track and saturating a head pole corner.

23. The method according to claim 22, comprising:
forming a perpendicular magnetic recording medium wherein said write current I_{w} is equal to said saturation current Iₛₐₜ, and said thickness t of said SUL is determined based upon the design rule:
t>(λM_{s(head)}/M_{s(SUL)}.

24. The method according to claim 22, comprising:
forming said perpendicular magnetic recording medium wherein said thickness t of said SUL is selected from the following:
(a) the calculated thickness tcalc according to said design rule;
(b) between about 0.7 and about 1.5 times t_{calc}; and
(c) between about 0.8 and about 1.2 times t_{calc}

25. The method according to claim 21, comprising
forming a said perpendicular magnetic recording medium wherein said SUL comprises a layer of an amorphous magnetic material which includes a smooth surface facing said magnetically hard recording layer; and said amorphous magnetic material is free from low frequency noise and stripe domains and has a high M_{s(SUL)} value at least about 1,500 emu/cm³ for minimizing said thickness t of said SUL.

26. The method according to claim 25, comprising:
forming a perpendicular magnetic recording medium wherein M_{s(SUL)}t of said SUL is <˜15 memu/cm².

27. The method according to claim 25, comprising:
forming a perpendicular magnetic recording medium wherein M_{s(SUL)}t of said SUL is >˜15 memu/cm².

28. The method according to claim 27, comprising:
forming a perpendicular magnetic recording medium wherein said SUL comprises a laminated structure including a plurality of layers of said amorphous magnetic material separated by respective thin spacer layers of a non-magnetic material or a pseudo-laminated structure including a stacked plurality of contacting sub-layers of said amorphous magnetic material.

29. The method according to claim 21, comprising:
forming at least said SUL by sputter deposition.

30. The method according to claim 21, comprising:
providing a non-magnetic glass or Al-based alloy substrate with an adhesion layer comprising a non-magnetic amorphous material on said surface, and forming thereon a layer stack including a laminated SUL comprised of a plurality of amorphous Fe-based alloy layers separated by amorphous, non-magnetic spacer layers, an hcp interlayer with <0001> preferred growth orientation, a small-grain, low exchange coupled, hcp Co-based alloy magnetic recording layer, a hard carbon-containing protective overcoat, and a lubricant topcoat.
